(19) United States
(12) Patent Application Publication
(10) Pub. No.: US 2024/0218473 A1
(43) Pub. Date: Jul. 4, 2024

(54) SUPPLIED HEAT QUANTITY ESTIMATION METHOD, SUPPLIED HEAT QUANTITY ESTIMATION DEVICE, SUPPLIED HEAT QUANTITY ESTIMATION PROGRAM, AND BLAST FURNACE OPERATION METHOD

(71) Applicant: JFE STEEL CORPORATION, Tokyo (JP)

(72) Inventors: Kazuhira ICHIKAWA, Tokyo (JP); Tetsuya YAMAMOTO, Tokyo (JP); Takeshi SATO, Tokyo (JP); Yuki KAWASHIRI, Tokyo (JP)

(73) Assignee: JFE STEEL CORPORATION, Tokyo (JP)

(21) Appl. No.: 18/289,170

(22) PCT Filed: Mar. 25, 2022
(86) PCT No.: PCT/JP2022/014486

§ 371 Date: Nov. 1, 2023

(30) Foreign Application Priority Data
Jun. 28, 2021 (JP) 2021-106364

(51) Int. Cl. C21B 7/24; C21B 5/00

(52) U.S. Cl. CPC C21B 7/24; C21B 5/00

(57) ABSTRACT

A supplied heat quantity estimation method includes an estimation step of estimating a change in carried out sensible heat by in-furnace passing gas and a change in carried in sensible heat supplied by a raw material preheated by the in-furnace passing gas, and estimating a quantity of heat supplied to pig iron in a blast furnace in consideration of the estimated changes of the carried out sensible heat and the carried in sensible heat. The estimation step includes a step of estimating a quantity of heat supplied to pig iron in consideration of heat dissipated from the blast furnace during an air blowing break, and a step of estimating a quantity of heat held in deadman coke present in the blast furnace, and estimating the quantity of heat supplied to pig iron in consideration of the estimated quantity of heat held in deadman coke.

### FIELD

The present invention relates to a supplied heat quantity estimation method, a supplied heat quantity estimation device, a supplied heat quantity estimation program that are for estimating the quantity of heat supplied to pig iron in a blast furnace, and a blast furnace operation method.

### BACKGROUND

Generally, in order to stably operate a blast furnace, the molten iron temperature needs to be maintained within a predetermined range. Specifically, in a case where the molten iron temperature is low, the viscosity of molten iron and slag generated together with the molten iron increases, and the molten iron or the slag is made difficult to be discharged from an iron outlet. On the other hand, in a case where the molten iron temperature is high, the Si concentration in the molten iron increases and the viscosity of the molten iron increases, and accordingly, there is a high risk that the molten iron clings to a tuyere and melts the tuyere. Therefore, in order to stably operate a blast furnace, the fluctuation of the molten iron temperature needs to be reduced. From such a background, various methods for estimating the quantity of heat supplied into a blast furnace and the molten iron temperature have been proposed. Specifically, Patent Literature 1 discloses a furnace heat control method for a blast furnace, including sequentially estimating a furnace heat index displacement amount at the present time from a furnace heat index reference level corresponding to a target molten iron temperature, a descending speed displacement amount at the present time from a descending speed reference level of a furnace top corresponding to the target molten iron temperature, and a molten iron temperature after a specific time from an influence time of both displacement amounts on the molten iron temperature, and performing a furnace heat control operation such that a molten iron temperature fluctuation is reduced based on the estimation result. Furthermore, Patent Literature 2 discloses a future molten iron temperature prediction method for a blast furnace for predicting a future molten iron temperature based on operation data including an actual value of blast condition data including at least one of a blown air temperature, a blown air humidity, a blown air amount, a pulverized coal blow-by amount, or an oxygen enrichment amount in a blast furnace, an actual value of disturbance factor data including at least a solution loss carbon amount, and an actual value of a molten iron temperature, the method including a data accumulation process of accumulating operation data, a steady state prediction model construction process of constructing a steady state prediction model for predicting a molten iron temperature in a steady state from operation data in a steady state accumulated in the data accumulation process, a non-steady state prediction model construction process of constructing a non-steady state prediction model for predicting a molten iron temperature in a non-steady state from operation data in a non-steady state accumulated in the data accumulation process, the non-steady state prediction model being obtained by reducing a dimension of the steady state prediction model, and a molten iron temperature prediction process of predicting a molten iron temperature from the constructed steady state prediction model and non-steady state prediction model.

### CITATION LIST

### Patent Literature

Patent Literature 1: JP H2-115311 A
Patent Literature 2: JP 2008-144265 A

### SUMMARY

### Technical Problem

The timing at which there is a high possibility that a molten iron temperature greatly fluctuates is when the amount of molten iron produced changes due to a change in the operation rate such as the amount of air blown into the blast furnace, and the amount of pig iron changes with respect to the quantity of heat supplied into the blast furnace. Since heat held in the blast furnace is dissipated particularly during an air blowing break in which air blowing to the blast furnace is temporarily paused, the heat compensation is required at the time of starting the blast furnace after the air blowing break. Furthermore, depending on the form of the air blowing break, the operation may be performed by lowering the height of the surface of the raw material charged in the blast furnace and backfilling the room-temperature raw material again at the time of starting the blast furnace after the air blowing break, and in this case, heat compensation of the room temperature raw material is also required. Therefore, in order to accurately estimate the quantity of heat supplied to pig iron in the blast furnace, such heat compensation needs to be considered. However, since the method described in Patent Literature 1 does not take into consideration a factor such as carried out sensible heat by blown air sensible heat that is considered to change due to an increase or decrease in the operation rate, the quantity of heat supplied to pig iron when the operation rate is greatly changed cannot be accurately estimated. On the other hand, in the method described in Patent Literature 2, it is considered that the estimation accuracy of the molten iron temperature decreases when an operation change that has not been accumulated in the past is made. Furthermore, in a case where the estimation accuracy of the molten iron temperature is low as described above, there are many cases where excessive heat supply occurs, and there is a concern about equipment trouble. Furthermore, excessive use of a reducing material that is a carbon source is not preferable also from the perspective of reducing carbon dioxide emissions.

The present invention has been made in view of the above issues, and an object of the present invention is to provide a supplied heat quantity estimation method, a supplied heat quantity estimation device, and a supplied heat quantity estimation program capable of accurately estimating the quantity of heat supplied to pig iron in a blast furnace when the operation rate greatly changes, particularly even in starting the blast furnace after an air blowing break. Another object of the present invention is to provide a blast furnace operation method in which a molten iron temperature can be accurately controlled within a predetermined range while the quantity of heat supplied to pig iron in the blast furnace is appropriately maintained when the operation rate greatly changes, particularly even in starting the blast furnace after an air blowing break.

### Solution to Problem

A supplied heat quantity estimation method according to the present invention estimates a quantity of heat supplied to pig iron in a blast furnace from a quantity of heat supplied into the blast furnace and a production speed of molten iron in the blast furnace, and includes an estimation step of estimating a change in carried out sensible heat by in-furnace passing gas and a change in carried in sensible heat supplied by a raw material preheated by the in-furnace passing gas, and estimating the quantity of heat supplied to pig iron in the blast furnace in consideration of the estimated changes of the carried out sensible heat and the carried in sensible heat, wherein the estimation step includes a step of estimating the quantity of heat supplied to pig iron in the blast furnace in consideration of heat dissipated from the blast furnace during an air blowing break, and a step of estimating a quantity of heat held in deadman coke present in the blast furnace, and estimating the quantity of heat supplied to pig iron in the blast furnace in consideration of the estimated quantity of heat held in deadman coke.

The estimation step may include a step of estimating a change in the carried in sensible heat in consideration of a surface height of a raw material lowered during an air blowing break.

A supplied heat quantity estimation device according to the present invention estimate a quantity of heat supplied to pig iron in a blast furnace from a quantity of heat supplied into the blast furnace and a production speed of molten iron in the blast furnace, and includes an estimation unit configured to estimate a change in carried out sensible heat by in-furnace passing gas and a change in carried in sensible heat supplied by a raw material preheated by the in-furnace passing gas, and estimate the quantity of heat supplied to pig iron in the blast furnace in consideration of the estimated changes of the carried out sensible heat and the carried in sensible heat, wherein the estimation unit is configured to estimate a change in the carried in sensible heat in consideration of a surface height of a raw material lowered during an air blowing break, estimate the quantity of heat supplied to pig iron in the blast furnace in consideration of heat dissipated from the blast furnace during an air blowing break, estimate a quantity of heat held in deadman coke present in the blast furnace, and estimate the quantity of heat supplied to pig iron in the blast furnace in consideration of the estimated quantity of heat held in deadman coke.

The estimation unit may be configured to estimate a change in the carried in sensible heat in consideration of a surface height of a raw material lowered during an air blowing break.

A supplied heat quantity estimation program according to the present invention causes a computer to execute processing of estimating a quantity of heat supplied to pig iron in a blast furnace from a quantity of heat supplied into the blast furnace and a production speed of molten iron in the blast furnace, and causes the computer to execute estimation processing of estimating a change in carried out sensible heat by in-furnace passing gas and a change in carried in sensible heat supplied by a raw material preheated by the in-furnace passing gas, and estimating the quantity of heat supplied to pig iron in the blast furnace in consideration of the estimated changes of the carried out sensible heat and the carried in sensible heat, wherein the estimation processing includes processing of estimating a change in the carried in sensible heat in consideration of a surface height of a raw material lowered during an air blowing break, estimating the quantity of heat supplied to pig iron in the blast furnace in consideration of heat dissipated from the blast furnace during an air blowing break, estimating a quantity of heat held in deadman coke present in the blast furnace, and estimating the quantity of heat supplied to pig iron in the blast furnace in consideration of the estimated quantity of heat held in deadman coke.

A blast furnace operation method according to the present invention includes a step of controlling a quantity of heat supplied into the blast furnace based on the quantity of heat supplied to pig iron in the blast furnace estimated by the supplied heat quantity estimation method according to the present invention.

### Advantageous Effects of Invention

According to a supplied heat quantity estimation method, a supplied heat quantity estimation device, and a supplied heat quantity estimation program according to the present invention, the quantity of heat supplied to pig iron in a blast furnace can be accurately estimated when the operation rate greatly changes, particularly even in starting the blast furnace after an air blowing break. According to a blast furnace operation method according to the present invention, a molten iron temperature can be accurately controlled within a predetermined range while the quantity of heat supplied to pig iron in the blast furnace is appropriately maintained when the operation rate greatly changes, particularly even in starting the blast furnace after an air blowing break.

### BRIEF DESCRIPTION OF DRAWINGS

FIG. 1 is a block diagram illustrating a configuration of a furnace heat control device according to one embodiment of the present invention.

FIG. 2 is a flowchart illustrating a flow of furnace heat control processing according to the one embodiment of the present invention.

FIG. 3 is a diagram illustrating an example of a relationship between a conventional index and a furnace heat index of the present invention, and a temperature difference from a reference molten iron temperature.

### DESCRIPTION OF EMBODIMENTS

Hereinafter, a configuration and operation of a furnace heat control device according to one embodiment of the present invention to which a supplied heat quantity estimation method and a supplied heat quantity estimation device according to the present invention are applied will be described with reference to the drawings.

### [Configuration]

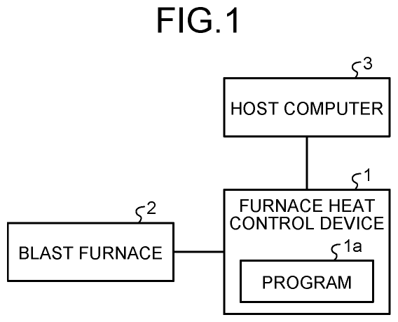

First, a configuration of a furnace heat control device according to one embodiment of the present invention will be described with reference to FIG. 1. FIG. 1 is a block diagram illustrating a configuration of the furnace heat control device according to the one embodiment of the present invention. As illustrated in FIG. 1, a furnace heat control device 1 according to the one embodiment of the present invention includes an information processing device such as a computer, and controls the temperature of molten iron produced in a blast furnace 2 within a predetermined range by controlling the quantity of heat supplied to a melt in the blast furnace 2 from a tuyere disposed in a lower part of the blast furnace 2. The furnace heat control device 1 functions as a supplied heat quantity estimation device according to the present invention.

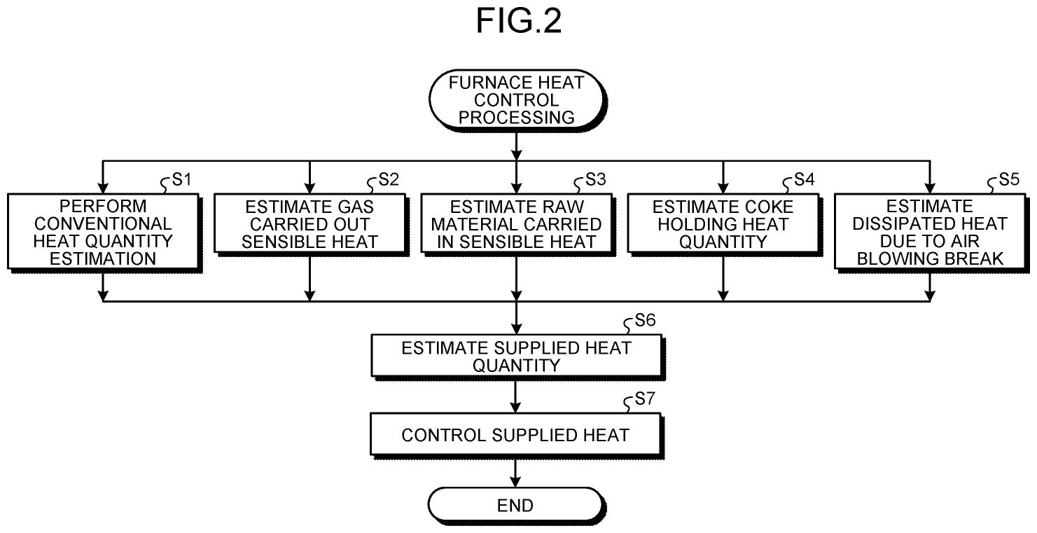

The furnace heat control device 1 having such a configuration, by executing furnace heat control processing described below, accurately estimates the quantity of heat supplied to pig iron in the blast furnace 2 when the operation rate of the blast furnace 2 greatly changes, particularly even in starting the blast furnace after an air blowing break, and accurately controls the molten iron temperature within a predetermined range while appropriately maintaining the quantity of heat supplied to pig iron in the blast furnace 2 using the estimation result. Hereinafter, a flow of the furnace heat control processing according to the one embodiment of the present invention will be described with reference to FIG. 2.

Note that the operation of the furnace heat control device 1 described below is implemented by an arithmetic processing device such as a CPU in the information processing device included in the furnace heat control device 1 loading a program 1a from a storage unit such as a ROM to a temporary storage unit such as a RAM and executing the loaded program 1a. The program 1a may be provided by being recorded in a computer-readable recording medium such as a CD-ROM, a flexible disk, a CD-R, or a DVD as a file in an installable format or an executable format. The program 1a may be stored in a computer connected to a network such as a telecommunication line such as the Internet, a telephone communication network such as a mobile phone, or a wireless communication network such as WiFi (registered trademark), and provided by being downloaded via the network.

### [Furnace Heat Control Processing]

FIG. 2 is a flowchart illustrating a flow of furnace heat control processing according to the one embodiment of the present invention. The flowchart illustrated in FIG. 2 starts at a timing when an execution command of the furnace heat control processing is input to the furnace heat control device 1, and in the furnace heat control processing, processing of steps S2, S3, and S4 is performed in addition to processing of step S1 of estimating the quantity of heat supplied into the blast furnace by a reaction heat balance (heat of reaction generation, reaction endotherm) in the blast furnace, blown air sensible heat, heat loss (quantity of heat removed from the furnace body or the like), and the like, which has been conventionally performed, the processing is integrated, and then processing of step S5 of estimating the supplied heat quantity is proceeded to. The processing of step S1 of estimating the quantity of heat supplied into the blast furnace by the reaction heat balance (heat of reaction generation, reaction endotherm) in the blast furnace, blown air sensible heat, heat loss (quantity of heat removed from the furnace body or the like), and the like is conventionally performed, and the supplied heat quantity at this time is set as Q₀. A preferred example of the processing in step S1 will be described below.

In the processing of step S2, the furnace heat control device 1 estimates sensible heat (gas carried out sensible heat) Q₇ carried out to the upper part of the blast furnace 2 by the gas (in-furnace passing gas) passing from the lower part to the upper part of the blast furnace 2. Specifically, the gas carried out sensible heat Q₇ (MJ/t-p: quantity of heat per ton of pig iron. Hereinafter, t-p represents pig iron tonnage) can be calculated by multiplying a temperature difference between an estimated temperature of gas combusted in front of the tuyere and a reference temperature representing a temperature of the upper end of the lower part of the blast furnace by the specific heat of the gas, and is expressed by the following Formula (1). As a result, the processing of step S2 is completed, and the processing proceeds to the processing of step S5.

$${Q}_{7} = α \cdot \{ \sum ( {C}_{i} \cdot {V}_{i} ) \} \cdot ( TFT - {T}_{base} ) \cdot \frac{1}{Pig} \qquad ( 1 )$$

Here, Cᵢ represents the specific heat (MJ/m³/° C.) of the gas species i (nitrogen, carbon monoxide, hydrogen), Vᵢ represents the flow rate (m³ (s.t.p)/min) (m³ (s.t.p): 0° C., volume at 1 atm (atmospheric pressure)) of the gas species i in Bosch gas, TFT represents a theoretical combustion temperature (° C.), T_{base} represents a reference temperature (° C.) (800 to 1200° ° C., preferably 900 to 1000° C.), Pig represents an iron making speed (t-p/min), and α represents an influence coefficient changed by the blast furnace 2. These values can be acquired from a host computer 3 such as a process computer connected to the furnace heat control device 1 via a telecommunication line, for example.

In the processing of step S3, the furnace heat control device 1 estimates sensible heat (raw material carried in sensible heat) Q₈ carried in to the lower part of the blast furnace 2 by the raw material supplied from the upper part to the lower part of the blast furnace 2. Specifically, the raw material carried in sensible heat Q₈ (MJ/t-p) can be calculated by multiplying the temperature difference between the raw material temperature T₁ (=1450 to 1500° C.) at the lower end of a fusion zone and the reference temperature T_{base} by the specific heat of the raw material as indicated by the following Formula (2). Note that the raw material temperature T₁ is a function of the surface height (descent height) Lᵢₙᵢₜᵢₐₗ of the raw material lowered during the air blowing break as indicated in the following Formula (3). According to the setting of the raw material temperature T₁, heat compensation of the room temperature raw material in a case where the operation is performed by backfilling the room temperature raw material again at the time of starting the blast furnace after the air blowing break can be considered, and thus, a decrease in the quantity of heat carried into the lower part of the furnace by the raw material can be accurately evaluated. As a result, the processing of step S3 is completed, and the processing proceeds to the processing of step S5.

$${Q}_{8} = β \cdot \{ \sum ( {C}_{j} \cdot {R}_{j} ) \} \cdot ( {T}_{1} - {T}_{base} ) \qquad ( 2 )$$

Here, Cⱼ represents specific heat)(MJ/kg/° C.) of a raw material j (coke, pig iron, slag), Rⱼ represents a basic unit (kg/t-p) of the raw material j, T₁ represents a raw material temperature (° C.) at the lower end of the fusion zone, T_{base} represents the reference temperature (° C.), and β represents an influence coefficient changed by the blast furnace 2. These values can be acquired from, for example, the host computer 3.

$${T}_{1} = f ( {L}_{initial} ) \qquad ( 3 )$$

In the processing of step S4, the furnace heat control device 1 estimates the quantity of heat (coke holding heat quantity) Q₉ held in the deadman coke present in the lower part of the blast furnace 2. Specifically, the coke holding heat quantity Q₉ (MJ/t-p) can be obtained by multiplying a value obtained by subtracting a combustion consumption amount and a carbon amount discharged as dust from a coke basic unit per 1 t of molten iron by a difference between a reference temperature and a theoretical combustion temperature and specific heat of coke C_{coke}, and is expressed by the following Formula (4). As a result, the processing of step S4 is completed, and the processing proceeds to the processing of step S5.

$${Q}_{9} = γ \cdot {C}_{Coke} \cdot ( δ \cdot TFT - {T}_{base} ) \cdot \{ CR - \frac{( {CR}_{burn} - PCR \cdot {C}_{inPC} ) + {C}_{sol} + Dust \cdot {C}_{indust}}{0.88} \} \qquad ( 4 )$$

Here, C_{coke} represents the specific heat of coke (MJ/kg/° C.), TFT represents the theoretical combustion temperature (° C.), T_{base} represents the reference temperature (° C.), CR represents a coke ratio (kg/t-p), CR_{burn} represents a pre-tuyere combustion carbon ratio (amount of oxygen consumed in front of the tuyere by blown air oxygen and humidity control) (kg/t-p), PCR represents a pulverized coal ratio (kg/t-p), C_{inPC} represents a carbon ratio in pulverized coal, Cₛₒₗ represents a solution loss carbon ratio (kg/t-p), Dust represents a dust ratio (kg/t-p), C_{indust} represents a carbon ratio in dust, and γ and δ represent influence coefficients changed by the blast furnace 2. These values can be acquired from, for example, the host computer 3.

In the processing of step S5, the furnace heat control device 1 estimates dissipated heat Q₁₀ due to an air blowing break. The dissipated heat Q₁₀ (MJ/t-p) due to the air blowing break can be obtained by the following Formula (5). Use of a part of the quantity of heat supplied to the lower part of the blast furnace for heat increase of the furnace body until the dissipated heat Q₁₀ is eliminated can be evaluated by considering the dissipated heat Q₁₀ due to the air blowing break. As a result, the processing of step S5 is completed, and the processing proceeds to the processing of step S6.

$$\begin{matrix}{Q}_{10} = \frac{a \cdot Q}{b \cdot {t}_{2} + c} \\ Q = ( {t}_{1} )\end{matrix} \} \qquad ( 5 )$$

Here, Q is an integral value (MJ/min) of the quantity of heat dissipated per unit time during the air blowing break, t₁ is an air blowing break time (min), t₂ is an elapsed time (min) from the start of the blast furnace after the air blowing break, and a, b, and c are coefficients in consideration of the influence of the capacity of a cooling facility of the blast furnace body and the like. Note that the quantity of heat removed (=amount of water passing to cooling device installed in outer peripheral portion of blast furnace*(water temperature on outlet side−water temperature on inlet side)*specific heat of cooling water) per unit time during the air blowing break by the cooling device is constantly measured. Therefore, the quantity of heat removed during the air blowing break, that is, the quantity of heat dissipated during the air blowing break, for example, by multiplying the measured value by a predetermined coefficient and the air blowing break time.

In the processing of step S6, the furnace heat control device 1 estimates the quantity of heat supplied to pig iron in the blast furnace 2 using the supplied heat quantity Q₀ estimated in the processing of step S1, the gas carried out sensible heat Q₇, the raw material carried in sensible heat Q₈, the coke holding heat quantity Q₉, and the dissipated heat Q₁₀ by the air blowing break that are estimated in the processing of steps S2 to S5. Specifically, the furnace heat control device 1 calculates a furnace heat index T_{Q} (MJ/t-p) corresponding to the quantity of heat supplied to pig iron in the blast furnace 2 by substituting the supplied heat quantity Q₀ estimated in step S1, the gas carried out sensible heat Q₇, the raw material carried in sensible heat Q₈, the coke holding heat quantity Q₉, and the dissipated heat Q₁₀ by the air blowing break that are estimated in the processing of steps S2 to S5 into the following Formula (6). As a result, the processing of step S6 is completed, and the processing proceeds to the processing of step S7.

$${T}_{Q} = {Q}_{0} - {Q}_{7} + {Q}_{8} - {Q}_{9} - {Q}_{10} \qquad ( 6 )$$

Here, Q₀ represents the quantity of heat supplied into the blast furnace by the reaction heat balance (heat of reaction generation, reaction endotherm) in the blast furnace, blown air sensible heat, heat loss (quantity of heat removed from the furnace body or the like), and the like, and an estimation method adopted in many cases in the conventional supplied heat quantity estimation can be applied, but as a preferable form, Formula (7) can be cited.

$${Q}_{0} = {Q}_{1} + {Q}_{2} - {Q}_{3} - {Q}_{4} - {Q}_{5} - {Q}_{6} \qquad ( 7 )$$

Here, Q₁ represents combustion heat (MJ/t-p) of post-tuyere coke. The combustion heat Q₁ can be calculated by dividing the calorific amount due to combustion of coke calculated from the amount of oxygen blown from the tuyere to the blast furnace per unit time by the amount of molten iron produced per unit time.

Furthermore, Q₂ represents blown air sensible heat (MJ/t-p) input to the blast furnace by blown air from the tuyere. The blown air sensible heat Q₂ can be calculated by obtaining the quantity of heat input to the blast furnace by blown air per unit time from the blown air amount per unit time and the measured value of the blown air temperature, and dividing this value by the amount of molten iron produced per unit time.

Furthermore, Q₃ represents solution loss reaction heat (MJ/t-p). For this value, for example, as described in Patent Literature 1, the reaction heat can be calculated by obtaining the solution loss carbon amount from the furnace top gas component value. The solution loss reaction heat Q₃ can be calculated by dividing the solution loss reaction heat by the amount of molten iron produced per unit time.

Furthermore, Q₄ represents heat of decomposition (MJ/t-p) of moisture mainly contained in blown air. The heat of decomposition Q₄ can be calculated by dividing heat of decomposition obtained from the measured value of the blown air moisture by the amount of molten iron produced per unit time.

Furthermore, Q₅ represents heat loss from the furnace body (for example, quantity of heat removed by cooling water) (MJ/t-p). In a case where the quantity of heat removed by cooling water is calculated as the heat loss, the quantity of heat removed Q₅ can be calculated by calculating the quantity of heat removed by the cooling water per unit time from the amount of the cooling water and the temperature difference between the inlet side and the outlet side of the cooling water of the furnace body of the blast furnace, and dividing the calculated quantity of heat removed by the amount of molten iron produced per unit time.

Furthermore, Q₆ represents the heat of decomposition (MJ/t-p) of the reducing material blown from the tuyere per unit time. The heat of decomposition Q₆ can be calculated by dividing the heat of decomposition by the amount of molten iron produced per unit time.

In the processing of step S7, the furnace heat control device 1 controls the quantity of heat supplied from the tuyere into the blast furnace 2 based on the quantity of heat supplied to pig iron in the blast furnace 2 estimated in the processing of step S6, thereby appropriately maintaining the quantity of heat supplied to the pig iron in the blast furnace 2 and controlling the molten iron temperature within a predetermined range. As a result, the processing of step S7 is completed, and a series of the furnace heat control processing ends.

As is apparent from the above description, in the furnace heat control processing according to the one embodiment of the present invention, the furnace heat control device 1 estimates a change in carried out sensible heat to the upper part of the blast furnace by in-furnace passing gas and a change in carried in sensible heat supplied to the lower part of the blast furnace by a raw material preheated by the in-furnace passing gas, and estimates the quantity of heat supplied to pig iron in the blast furnace in consideration of the estimated changes of the carried out sensible heat and the carried in sensible heat. Furthermore, the furnace heat control device 1 estimates the quantity of heat supplied to pig iron in the blast furnace in consideration of the heat dissipated from the blast furnace during an air blowing break, estimates the quantity of heat held in deadman coke present in the blast furnace, and estimates the quantity of heat supplied to the pig iron in the blast furnace in consideration of the estimated quantity of heat held in the deadman coke. As a result, the quantity of heat supplied to the pig iron in the blast furnace can be accurately estimated when the operation rate such as the amount of air blown into the blast furnace greatly changes, particularly even in starting the blast furnace after the air blowing break. As a result, the molten iron temperature can be accurately controlled within a predetermined range while the quantity of heat supplied to the pig iron in the blast furnace is appropriately maintained when the operation rate greatly changes, particularly even in starting the blast furnace after the air blowing break.

### EXAMPLE

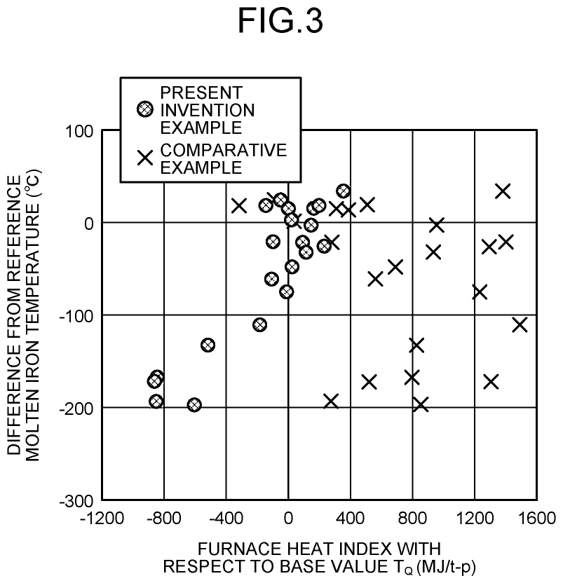

FIG. 3 indicates results of comparing a conventional furnace heat index (estimated by Q₁ to Q₆) and a furnace heat index (estimated by Q₁ to Q₁₀) of the present invention in starting a blast furnace after an air blowing break with an actual molten iron temperature (difference from the reference molten iron temperature). As indicated in FIG. 3, in the furnace heat index of the present invention (present invention example), a certain correlation between the furnace heat index and the molten iron temperature (difference from the reference molten iron temperature) can be confirmed as compared with the conventional furnace heat index (comparative example). Furthermore, Table 1 indicates a summary of the standard deviation of the difference between the estimated molten iron temperature and the actual molten iron temperature when each factor is taken into consideration. It can be seen that the estimation accuracy is improved in the case where the descent height due to the air blowing break and the dissipated heat are considered (Present Invention Example 1. Estimate the furnace heat index using Q₁ to Q₁₀. Q₈ is corrected according to the descent height) and the case where only the heat dissipated due to the air blowing break is considered (Present Invention Example 2. Estimate the furnace heat index using Q₁ to Q₁₀. Provided that Q₈ is not corrected according to the descent height) as compared with the case where the furnace heat index is estimated using only Q₁ to Q₆ as the conventional furnace heat index (Comparative Example 1) or the case where the descent height and the dissipated heat due to the air blowing break are not considered (Comparative Example 2. Estimate furnace heat index using Q₁ to Q₉. Provided that Q₈ is not corrected according to the descent height). As a result, it can be seen that the molten iron temperature can be accurately controlled within a predetermined range while the quantity of heat supplied to the pig iron in the blast furnace is appropriately maintained when the operation rate greatly changes, particularly even in starting the blast furnace after the air blowing break, using the furnace heat index of the present invention.

TABLE 1

| | Compar- | Compar- | Present | Present |
|---|---|---|---|---|
| | ative | ative | Invention | Invention |
| | Example 1 | Example 2 | Example 1 | Example 2 |
| Considered | Q₁ to Q₆ | Q₁ to Q₉ | Q₁ to Q₁₀ | Q₁ to Q₁₀ |
| indexes | | | | (Case where |
| | | | | there is no |
| | | | | influence of |
| | | | | Q₈) |
| Standard deviation | 132.1 | 89.6 | 25.2 | 18.3 |
| of actual molten | | | | |
| iron temperature | | | | |
| with respect to | | | | |
| estimated molten | | | | |
| iron temperature | | | | |

Although the embodiment to which the invention made by the present inventors is applied has been described above, the present invention is not limited by the description and drawings constituting a part of the disclosure of the present invention according to the present embodiment. That is, other embodiments, examples, operation techniques, and the like made by those skilled in the art based on the present embodiment are all included in the scope of the present invention.

### INDUSTRIAL APPLICABILITY

According to the present invention, a supplied heat quantity estimation method, a supplied heat quantity estimation device, and a supplied heat quantity estimation program capable of accurately estimating the quantity of heat supplied to pig iron in a blast furnace when the operation rate greatly changes, particularly even in starting the blast furnace after an air blowing break can be provided. According to the present invention, a blast furnace operation method in which a molten iron temperature can be accurately controlled within a predetermined range while the quantity of heat supplied to pig iron in the blast furnace is appropriately maintained when the operation rate greatly changes, particularly even in starting the blast furnace after the air blowing break can be provided.

### REFERENCE SIGNS LIST

1 FURNACE HEAT CONTROL DEVICE
1a PROGRAM
2 BLAST FURNACE
3 HOST COMPUTER

1. A supplied heat quantity estimation method for estimating a quantity of heat supplied to pig iron in a blast furnace from a quantity of heat supplied into the blast furnace and a production speed of molten iron in the blast furnace, the supplied heat quantity estimation method comprising
an estimation step of
estimating a change in carried out sensible heat by in-furnace passing gas and a change in carried in sensible heat supplied by a raw material preheated by the in-furnace passing gas, and
estimating the quantity of heat supplied to pig iron in the blast furnace in consideration of the estimated changes of the carried out sensible heat and the carried in sensible heat,
wherein the estimation step includes
a step of estimating the quantity of heat supplied to pig iron in the blast furnace in consideration of heat dissipated from the blast furnace during an air blowing break, and
a step of estimating a quantity of heat held in deadman coke present in the blast furnace, and estimating the quantity of heat supplied to pig iron in the blast furnace in consideration of the estimated quantity of heat held in deadman coke.

2. The supplied heat quantity estimation method according to claim 1, wherein the estimation step includes a step of estimating a change in the carried in sensible heat in consideration of a surface height of a raw material lowered during an air blowing break.

3. A supplied heat quantity estimation device for estimating a quantity of heat supplied to pig iron in a blast furnace from a quantity of heat supplied into the blast furnace and a production speed of molten iron in the blast furnace, the supplied heat quantity estimation device comprising
an estimation unit configured to
estimate a change in carried out sensible heat by in-furnace passing gas and a change in carried in sensible heat supplied by a raw material preheated by the in-furnace passing gas, and
estimate the quantity of heat supplied to pig iron in the blast furnace in consideration of the estimated changes of the carried out sensible heat and the carried in sensible heat,
wherein the estimation unit is configured to
estimate a change in the carried in sensible heat in consideration of a surface height of a raw material lowered during an air blowing break,
estimate the quantity of heat supplied to pig iron in the blast furnace in consideration of heat dissipated from the blast furnace during an air blowing break,
estimate a quantity of heat held in deadman coke present in the blast furnace, and
estimate the quantity of heat supplied to pig iron in the blast furnace in consideration of the estimated quantity of heat held in deadman coke.

4. The supplied heat quantity estimation device according to claim 3, wherein the estimation unit is configured to estimate a change in the carried in sensible heat in consideration of a surface height of a raw material lowered during an air blowing break.

5. (canceled)

6. A blast furnace operation method comprising a step of controlling a quantity of heat supplied into the blast furnace based on the quantity of heat supplied to pig iron in the blast furnace estimated by the supplied heat quantity estimation method according to claim 1.

7. A blast furnace operation method comprising a step of controlling a quantity of heat supplied into the blast furnace based on the quantity of heat supplied to pig iron in the blast furnace estimated by the supplied heat quantity estimation method according to claim 2.

8. A non-transitory computer-readable recording medium on which an executable program for estimating a quantity of heat supplied to pig iron in a blast furnace from a quantity of heat supplied into the blast furnace and a production speed of molten iron in the blast furnace, the program causing a processor of a computer to execute:
an estimation step of
estimating a change in carried out sensible heat by in-furnace passing gas and a change in carried in sensible heat supplied by a raw material preheated by the in-furnace passing gas, and
estimating the quantity of heat supplied to pig iron in the blast furnace in consideration of the estimated changes of the carried out sensible heat and the carried in sensible heat,
wherein the estimation step includes
estimating a change in the carried in sensible heat in consideration of a surface height of a raw material lowered during an air blowing break,
estimating the quantity of heat supplied to pig iron in the blast furnace in consideration of heat dissipated from the blast furnace during an air blowing break,
estimating a quantity of heat held in deadman coke present in the blast furnace, and
estimating the quantity of heat supplied to pig iron in the blast furnace in consideration of the estimated quantity of heat held in deadman coke.
